(19) United States
(12) Patent Application Publication
(10) Pub. No.: US 2010/0005290 A1
(43) Pub. Date: Jan. 7, 2010

(54) METHOD OF IDENTITY PROTECTION, CORRESPONDING DEVICES AND COMPUTER SOFTWARES

(75) Inventors: Pascal Urien, Villepreux (FR); Mohamad Badra, Montrouge (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: Groupe Des Escoles Des Telecommunications- Ecole Nationale superieure Des Telecommunications, Paris (FR)

(21) Appl. No.: 12/296,392

(22) PCT Filed: Apr. 3, 2007
(86) PCT No.: PCT/EP07/53268

§ 371 Date: May 6, 2009

(30) Foreign Application Priority Data
Apr. 7, 2006 (FR) 06/03114

(51) Int. Cl. H04L 9/00; H04L 29/06

(52) U.S. Cl. 713/155; 713/151

(57) ABSTRACT

A method is provided for authenticating a client terminal with an authentication server. The client terminal holds an authentication certificate. The method includes the following phases: obtaining at least once encryption parameter by the client terminal; encrypting the authentication certificate by the client terminal, based on the at least one encryption parameter, delivering an encrypted authentication certificate; transmitting the encrypted authentication certificate to the server, obtaining the at least one encryption parameter by the server; obtaining the at east one encryption parameter by the server; decrypting the encrypted authentication certificate, based on the at least one encrypting parameter, authenticating and delivering an authentication assertion if the authentication is positive.

### CROSS-REFERENCE TO RELATED APPLICATIONS

This application is a Section 371 National Stage application of International Application No. PCT/EP2007/053268, filed Apr. 3, 2007, and published as WO 2007/115982 on Oct. 18, 2007, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

This disclosure relates to the field of identity protection inside a network.

More precisely, the disclosure concerns a method for protecting the identity of a user of networks.

The disclosure especially concerns security modules, for example chip cards, permitting the secure use of this method, which may be used on the user's terminal and/or on the server authenticating the user of a network.

The disclosure even further relates to a method for managing a plurality of security modules by an authentication server.

Within the scope of the disclosure, the term network is to be understood in the widest possible sense. It is used to designate home automation networks, based on ADSL modems and Wi-Fi access points, public networks equipped with base stations (UMTS, HSDPA, etc.) or hotspots (Wi-Fi, WiMax, etc.), company or public service networks using LAN, PLAN, WLAN or MAN type networks.

Similarly, the same network must be understood in the widest possible sense. It may designate for example a computer managed by an operating system. Furthermore, such a computer may be equipped with one or more communication interfaces described by many standards such as IEEE 802.3 (Ethernet standard), IEEE 802.11 (Wi-Fi standard), IEEE 802.16 (WiMax standard), IEEE 802.16e (WiMobile standard). It may also designate mobile communication terminals such as mobile telephones or personal assistants.

The term authentication server must also be understood in the widest possible sense. It designates a computer managed by an operating system comprising at least one communication interface and capable of providing authentication services.

### BACKGROUND OF THE DISCLOSURE

1. Prior Art

A major concern of private users, private or public organisations that use, manage or deploy communication services consists in guaranteeing the security of the information exchanged. This guarantee of the safety is especially demanded in the case of radio communication wherein it is possible to listen to information exchanged remotely (this method is sometimes called the parking lot attack.

The Internet Engineering Task Force designates under the AAA acronym (Authentication Authorisation Accounting) the means required to implement secure services that may be optionally invoiced in an IP protocol based communication infrastructure.

The process for authenticating a user usually consists in a user presenting a piece of identity to an authentication authority, then by this same user producing proof of the real property of this identity and the associated rights. An authentication protocol carries out all of the operations required for the phases where the identity is presented and obtaining the proof of this identity.

There are several authentication protocols. They control the access to the services offered by means of different layers of the OSI (Open systems interconnection) communication model:
Control of the access to the MAC layer (OSI layer n^{o} 2) of the local networks. This operating mode is especially used by the PPP (Point to Point Protocol) standards and the mobile communications standards:
Control of the access to the OSI layers n^{o} 3 and 4: IP and UDP/TCP transport (User Datagram Protocol and Transport Control Protocol) layer. This mode of operation is typically used to open qualified VPN (Virtual private Network) connections via an IKEv2 authentication protocol for example.

Due to the increase in security problems caused by the generalised use of communication networks, especially in radio environments, the IETF has ratified a standard called EAP (Extensible Authentication protocol). This standard permits the transport of multiple authentication scenarios, certain of which are defined by the EAP-TLS (RFC 2246), EAP-SIM (RFC 4186) and EAP-AKA (RFC 4187) specifications.

The EAP-TLS protocol, introduced by RFC 2246 is a transparent encapsulation of the TLS (Transport Layer Security) protocol that is precisely detailed by the document RFC 2716.

The EAP protocols may be applied to controlling the access to MAC (PPP compliant with RFC 2284, Ethernet and WiFi compliant with IEEE 802.1x, WiMax compliant with IEEE 802.16 and IEEE 802.16e), as well as VPN level services (IKEv2 described by RFC 4306, PPTP point to point tunnelling protocol, described by RFC 2637, L2F Cisco Layer two forwarding protocol described by RFC 2341).

TLS is an improved and non-proprietary version of the SSL (secure socket layer) protocol patented by Netscape (U.S. Pat. No. 5,657,390) which published version 2 at the end of 1994 and version 3 in November 1996.

In relation to FIG. 1, the standard operation of the TLS protocol is described.

In normal use, a web server (301) presents to the remote client (typically a web browser, 201) its identity (inserted in a certificate message 103) in the form of an X509 certificate. The client analyses the certificate from the server, and it especially checks the signature using the public key of a certification authority (K_{pubCA}) that it trusts. If this check is successful, the customer extracts the public key contained in the certificate (103, K_{pubS}) and chooses a random number of 48 octets, called the PreMasterSecret (107) that is transmitted to the server by means of the key K_{pubS} (in a ClientKeyExchange message).

All of the encrypting material that is useful for the TLS protocol are removed from the PreMasterSecret parameter. It may be observed that in this case the client does not reveal its identity and also that the identity of the server is circulated decrypted, which is to say not encoded, via Internet.

When the TLS protocol is used in an authentication scenario such as EAP-TLS, the authentication of the client is obligatory; this mutual authentication procedure is usually called Client Authentication handshake. The client transmits to the server its identity in decrypted form (in a certificate message 106) which is to say via its X509 certificate. It proves this identity by creating a handshake type signature that is exchanged beforehand between the two entities (client and server) by means of its private key K_{privC}. This information is transported via a message called CertificateVerify (108). The server verifies the identity of the server by means of two operations:

1. The analysis of the X509 certificate presented by the client, from which it especially extracts its public key K_{pubC}.

2. The correct value of the signature contained in the CertificateVerify message checked by means of the K_{pubC} key.

The use of the TLS protocol leads the client to reveal its identity during the identification phase.

2. Disadvantages of the Prior Art

One disadvantage of this technique of the prior art is that the EAP-TLS protocol does not guarantee the confidentiality of the client's identity.

Indeed, even though the EAP-TLS protocol is widely used for access control to WLAN (WiFi, WiMax) or VPN (IKEv2, etc.) services, the lack of protection of the identity of the client allows for example the obtaining outside of the company or administration walls of the list of the persons present.

The decrypted presentation of the identity also authorises the movements of a wireless network client to be observed, and consequently this interferes with the client's privacy.

The knowledge of the identity of the clients on a network using the EAP-TLS protocol is obtained by a passive or an active attack. A trivial passive attack consists of listening to the authentication exchanges and noting the list of clients present on the network.

In relation to FIG. 2, an active is described which uses the EAP-TLS protocol. In this scenario, the terminal of a client is equipped with a WiFi interface, and uses the EAP-TLS protocol. It thus behaves as a RFID (radio frequency identification) electronic label that may be read at a distance of 100 m and which allows the presence of a specific user to be determined.

A hacking access point (AP, 301) periodically broadcasts a SSID (service set identifier) identifier interpreted by the client station as the identifier of an authorised AP. In compliance with the IEEE 802.1x protocol, an authentication session is started. The client transmits an EAP-Start packet (102), the AP sends an EAP-Identity request message (104), the customer replies with the EAP-Identity.response message (104). The AP transmits an EAP-TLS Start message (105).

The client then sends an EAP-TLS response which contains the ClientHello TLS message (106). The rogue AP sends a ServerHello message (107) containing a certificate, which is to say an authentication server identity in which the client trusts.

This identity may be obtained by listening beforehand and analysing EAP-TLS messages, or with the knowledge of server certificates that by nature are not confidential. In compliance with the TLS protocol, the ServerHello message (107) does not have any security attributes and may be easily forged, provided that a valid server identity is inserted. This message is sent to the client in an EAP-TLS.request message (107). The client verifies the certificate of the server and transmits its identity in an EAP-TLS.response that carries a Certificate type TLS message (108). The attacker reaches its objective, obtaining a client identity remotely (109).

This description of a classic active attack highlights the major disadvantage of this authentication technique used by the EAP-TLS protocol, which obliges the client to reveal its identity.

### SUMMARY

An embodiment of the invention relates to an authentication method of a client terminal by an authentication server, wherein said client terminal has an authentication certificate.

According to an embodiment of the invention, such a method comprises the following phases:
at least one encrypting parameter is obtained by said client terminal;
said authentication certificate is encrypted by said client terminal, from said at least one encrypting parameter, providing an encrypted authentication certificate;
transmission of said encrypted authentication certificate to said server;
retrieval of said at least one encrypting parameter by said server;
decoding of said encrypted authentication certificate from said at least one encrypting parameter;
authentication and supplying of an assertion of the authentication if the authentication is positive.

Consequently, an embodiment of the invention is based on a completely novel and inventive approach to the authentication of clients within a network. Indeed, the difference to the usual conventional approaches of the prior art lies in the fact that an embodiment of the invention proposes that the authentication certificate of the client is encrypted before the latter is transferred to the server. The server is then responsible, using encrypting parameters that are known both to the server and to the client, for decoding this certificate and certifying the validity of the client authentication.

According to one specific aspect of an embodiment of the invention, said encrypting phase of said authentication certificate by said client terminals comprises the steps of:
calculating, by said client terminal, a certificate encryption key in function of at least one encrypting parameter;
encrypting said authentication certificate, using said certificate encryption key.

Consequently, the client terminal is able to calculate an encryption key according to a calculation function, from the encrypting parameters. It may then encrypt its certificate using this key, which it has calculated to obtain an encrypted certificate. The encryption of the certificate is therefore carried out on the client terminal.

According to one specific feature of an embodiment of the invention, said phase for retrieving said at least one encrypting parameter by said server comprises the following steps:
encrypting said at least one encrypting parameter by said client terminal in function of at least one public key transmitted by said server to said terminal;
transmission of said at least one encrypted encrypting parameter by said client terminal to said server;
decoding of said at least one encrypted encrypting parameter by said server in function of at least one private encryption key asymmetric to said at least one public encryption key.

The terminal encrypts, using the public key of the server, the encrypting parameters that have been used to calculate the encryption key of the certificate. Subsequently, the terminal transmits these encrypted parameters to the server. The server decodes these parameters using its private key. The server is therefore the only one that is able to decode these parameters (that have been encrypted using its public key). It is therefore not possible for a third party, to intercept these decoded parameters. This consequently provides a powerful mechanism for protecting the encryption data, by a double mechanism: the transmission of an encrypted authentication certificate and the transmission of the parameters used to encrypt the certificate, also encrypted.

According to one original aspect of an embodiment of the invention, said at least one encrypting parameter belongs to the group comprising at least:
an item of information that is representative of a random number obtained by said authentication server;
an item of information that is representative of a random number obtained by said client terminal;
an item of information that is representative of a number encrypted with said public key of said authentication server.

The parameters used for the encryption may have several origins: a random number from the server, a random number from the client, a number with the public key of the authentication server for example. In this way, it is ensured that the parameters used to encrypt the certificate are not constants or easily reproducible and that they may not be discovered by a third party. This consequently increases the protection of the client's identity.

According to one specific aspect of an embodiment of the invention, said method is implemented in the SSL and/or TLS protocol.

According to one original aspect, said method is implemented in the EAP protocol.

In this way, the identity protection method may be inserted into known authentication methods, by adding new functions.

An embodiment of the invention also relates to an identity encryption method of a client terminal which has an authentication certificate, during an authentication of said terminal by an authentication server.

According to an embodiment of the invention, such a method comprises the steps of:
retrieval of at least one encrypting parameter by said client terminal;
encrypting of said encrypted authentication certificate by said client terminal from said at least one encrypting parameter;
transmission of said encrypted authentication certificate to said server.

In this embodiment, the client terminal using the invention is able to encrypt its identity before it is transmitted to the authentication server. Such a method ensures that the identity of the terminal will not be transmitted decoded by a communication network.

An embodiment of the invention also relates to an identity encryption device of a client terminal which has an authentication certificate, during an authentication of said terminal by an authentication server.

According to an embodiment of the invention, such a device comprises means of:
retrieval of at least one encrypting parameter;
encrypting of said encrypted authentication certificate from said at least one encrypting parameter;
transmission of said encrypted authentication certificate to said server.

In this other embodiment, a device is allowed to encrypt the identity of a client terminal before it is transmitted to the server.

In one specific aspect of an embodiment of the invention, said identity encryption device is used in a chip card using a virtual machine.

Consequently, this identity encryption device may be fitted in a chip card, using an operating system, for example a virtual machine. According to one specific aspect, this virtual machine may be of the Java type and the chip card may be a java card.

An embodiment of the invention further relates to a method for decoding the identity of a client terminal which has an authentication certificate, by an authentication server in an authentication of said terminal by said authentication server.

According to an embodiment of the invention, such a method comprises the steps of:
the reception of an encrypted authentication certificate from said client terminal;
the retrieval of at least one encrypting parameter by said server;
the decoding of said encrypted authentication certificate from said at least one encrypting parameter;
the authentication and supply of an assertion of the authentication if the authentication is positive.

This method, according to one specific embodiment of the invention, thus permits the identity of a client terminal which protects its identity to be decoded.

An embodiment of the invention also relates to a device for decoding the identity of a client terminal which has an authentication certificate, in an authentication of said terminal by an authentication server.

According to an embodiment of the invention, such a device comprises means of:
the reception of an encrypted authentication certificate from said client terminal;
the retrieval of at least one encrypting parameter by said server;
the decoding of said encrypted authentication certificate from said at least one encrypting parameter;
the authentication and supply of an assertion of the authentication if the authentication is positive.

In this other embodiment, a device is able to decode the identity of a client terminal which has been transmitted to the server.

According to one specific aspect of an embodiment of the invention, said decoding device is used in a chip card using a virtual machine.

Consequently, this identity decoding device may be fitted in a chip card using an operating system, for example a virtual machine. According to one specific aspect, this virtual machine may be of the Java type and the chip card may be a java card.

In another embodiment, the invention relates to a computer software program that may be downloaded from a communication network and/or stored on a computer readable support and/or executable by a microprocessor.

In at least one embodiment, such a computer software program comprises program code instructions to execute an authentication process of a client terminal by an authentication server as previously described.

In another embodiment, the invention also relates to relates to a computer software program that may be downloaded from a communication network and/or stored on a computer readable support and/or executable by a microprocessor.

In at least one embodiment, such a computer software program comprises program code instructions to execute an identity encryption method for a client terminal as previously described.

In another embodiment, the invention also relates to relates to a computer software program that may be downloaded from a communication network and/or stored on a computer readable support and/or executable by a microprocessor.

In at least one embodiment, such a computer software program comprises program code instructions to execute an identity decoding method for a client terminal as previously described.

### BRIEF DESCRIPTION OF THE DRAWINGS

Other features and advantages will become clearer upon reading the following description of a preferred embodiment, provided simply by way of example and in no way restrictively, and the appended drawings, among which:

FIG. 1, already described, presents a sequence diagram illustrating the messages exchanged during a TLS session;

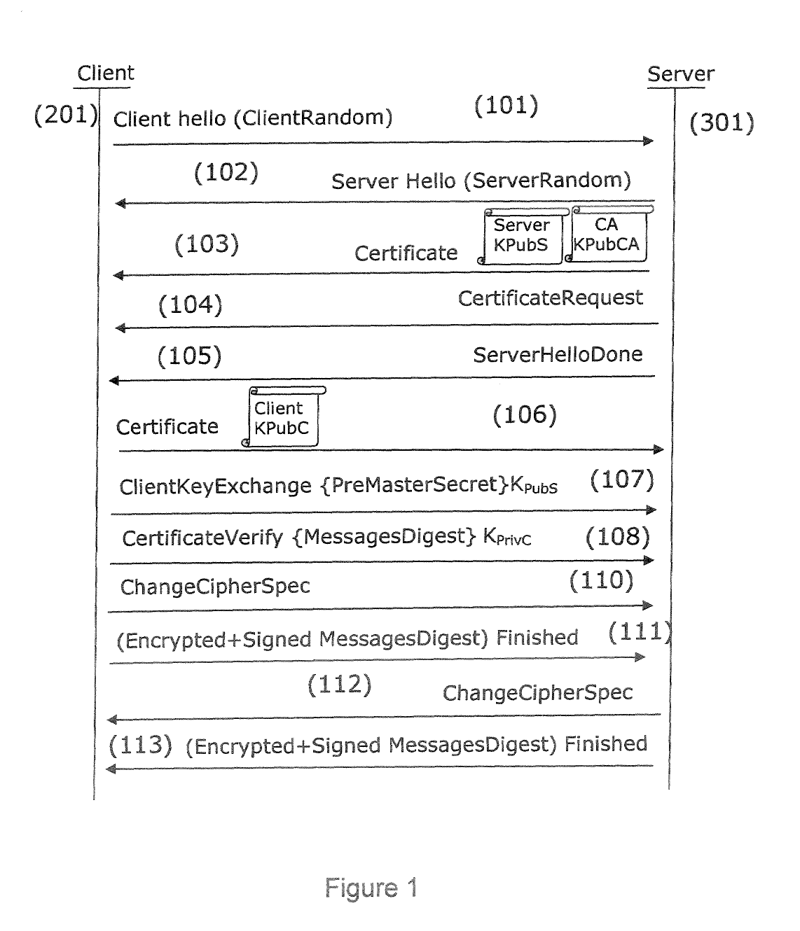

FIG. 2, also already described, presents a sequence diagram of the succession of steps of an attack aimed at collecting the identity of a client;

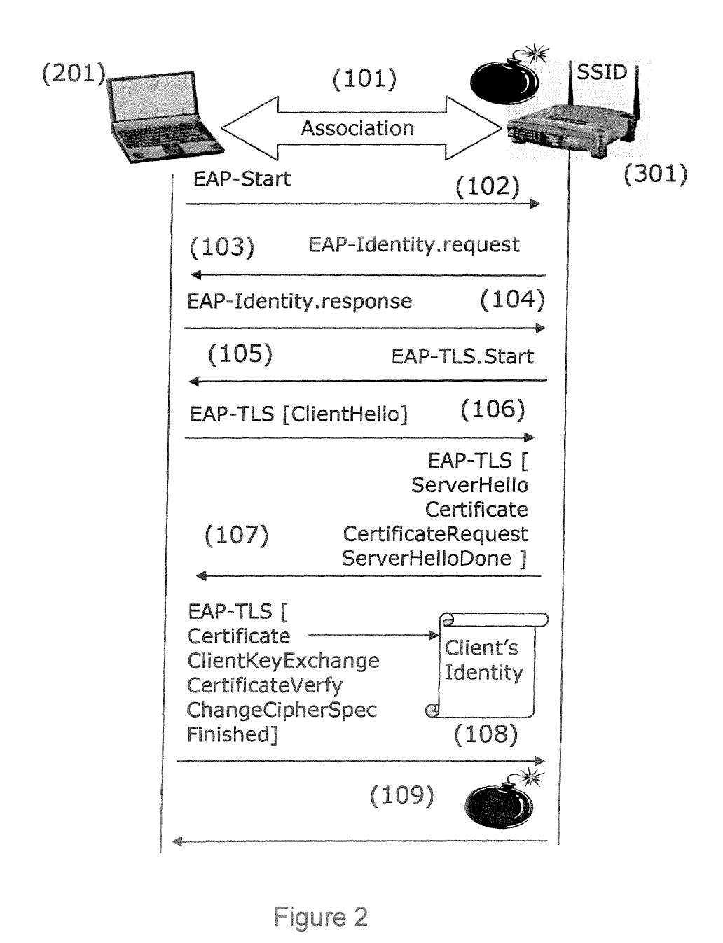

FIG. 3 presents a sequence diagram using an identity protection method according to an embodiment of the invention;

FIG. 4 details the structure of a security module;

FIG. 5 illustrates a practical embodiment of an EAP-TLS application in a java chip card context;

FIG. 6 is a sequence diagram presenting the use of a client security module according to an embodiment of the invention in the authentication of a client;

FIG. 7 is a sequence diagram presenting the use of a server security module according to an embodiment of the invention in the authentication of a client;

FIG. 8 presents a secure network architecture in which a RADIUS server, equipped with several security modules, manages multiple clients, also equipped with security modules;

FIG. 9 details the messages exchanged between a NAS and a RADIUS authentication server equipped with an EAP-TLS security module;

FIG. 10 illustrates the notion of a session identifier (session_ID) constructed using certain attributes of an Access Request packet and its use to process the EAP message by a specific security module.

### DETAILED DESCRIPTION OF ILLUSTRATIVE EMBODIMENTS

### 1. Reminder of the Principle of an Embodiment of the Invention

An embodiment of the invention thus proposes to protect the identity of the clients during authentication processes. This protection is even more important as the identity of users has become a real challenge both for operators and access providers, and even for the clients themselves, who do not wish to be monitored in their private lives.

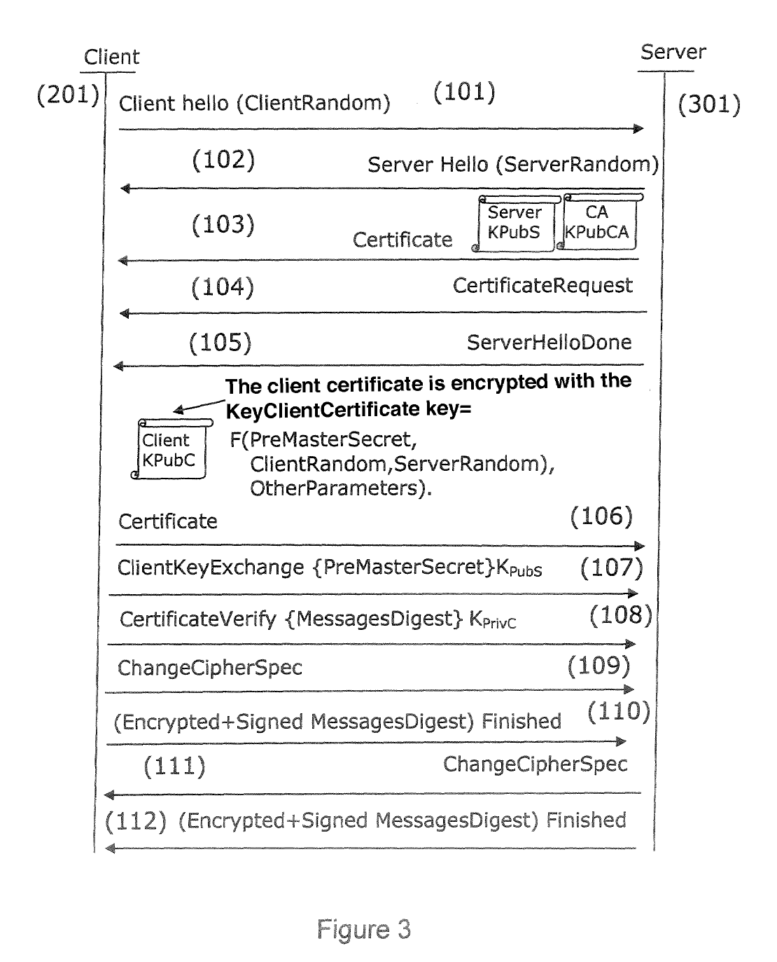

The general principle of an embodiment of the invention is based on the encryption of the identity by a security module. In relation to FIG. 3, an embodiment of the invention is described applied to the EAP-TLS protocol. However, the authentication method according to an embodiment of the invention may be used in any authentication methods where the client transmits its identity to the server.

In an EAP-TLS authentication process, the messages are exchanged in compliance with the TLS protocol. During a client authentication handshake session, the client (201) initiates the latter by a ClientHello message. The server responds by a set of ServerHello (102), Certificate (103), CertificateRequest (104) and ServerHelloDone (105) messages. The client then sends the Certificate (106), CertificateVerify (107), ClientKeyExchange (108), ChangeCipherSpec (109) and Finished (110) messages.

The certificate (106) message is an encrypted form of the client certificate. More precisely, and in compliance with the TLS protocol, the content of the message is a succession of certificates of which the first is attributed to the client, and the following certificates (present in option) are associated to one or several certification authorities.

By way of illustration, we will next describe a practical method of calculating the key used (KeyClientCertificate) to encrypt the client certificate (106). However other methods, based on secret formulae which make attacks more difficult may be used for this operation.

In the TLS protocol, the encryption keys may be generated using a Pseudo Random Function (PRF).

The shared MasterSecret is calculated from the PreMasterSecret parameter and two other random numbers (ClientRandom and ServerRandom) exchanged in the messages ClientHello (101) and ServerHello (102). The MasterSecret key may therefore be defined by:

MasterSecret=PRF(PreMasterSecret,“master secret”,Clientrandom|ServerRandom).

The sign | in this case designates a concatenation operation. Subsequently, in the authentication phase, other encryption keys are obtained using the MasterSecret parameter and a label (a chain of ASCII characters). These other keys also use the PRF function:

Keys=PRF(MasterSecret,Label,ServerRandom|ClientRandom)

According to an embodiment of the invention, the KeyClientCertificate encryption key is obtained by a relationship of the type (106):

KeyClientCertificate=F(PreMasterSecret,ServerRandom,ClientRandom,Otherparameters)

In this case, F is a function that uses PreMasterSecret, ServerRandom, ClientRandom and other calculation parameters (OtherParameters). For example, it is possible to use the following function:

KeyClientCertificate=PRF(MasterSecret,“clientcertificate”,ClientRandom|ServerRandom)

The client thus protects its identity by encrypting its X509 certificate, using an encryption algorithm, for example when running and otherwise the KeyClientCertificate key associated to this encryption algorithm, for example RC4 or AES in the counter mode. In compliance with the specifications of the TLS protocol, the print values (MD5 and SHA1 functions) used in messages such as CertificateVerify (108) and Finished (110, 112) are thus calculated taking into account the content of the encrypted client certificate (106). Indeed, this certificate appears in the Certificate message in encrypted form (106).

The server receives the *Certificate (106) and CertificateVerify (107) ClientKeyExchange (108), ChangeCipherSpec (109) and Finished (110) messages. It decodes the value of the PreMasterSecret contained in the ClientKeyExchange message (108) using its private key Kₚᵣᵢᵥₛ. It removes the key protecting the client certificate (106) by applying, using the decoded PreMasterSecret value, an encryption function identical to that applied by the client to obtain the value of the KeyClientCertificate. In one specific embodiment, applied to the TLS PRF function, the following formula is used:

KeyClientCertificate=PRF(MasterSecret,client certificate,ClientRandom|ServerRandom)

The server may then decode the client certificate.

The server then completes the opening phase of the TLS session by producing the two messages ChangeCipherSpec (111) and Finished (112).

Whereas in fact, PreMasterSecret can only be decoded by the server, as only the latter has the private key that can decode it. For example, in the case of EAP-TLS, PreMasterSecret is encrypted by the client, using the public server key of the K_{pubs} server, sent to the client by the server when the certificate (103) is transmitted. Whereas only the holder of the private key Kₚᵣᵢᵥₛ can decode the messages encrypted with this public key K_{pubs}.

In this way, the identity of the client is kept secret and only the server is able to decode this identity.

This therefore describes an embodiment of the method for encrypting the identity of the client used as part of the mutual authentication process using the EAP-TLS method. The client thus no longer shares its “decoded” identity on the network. This identity is encrypted and only the server with the adequate decoding information is able to identify the client to be authenticated. Indeed, in order to find the decoding key of the KeyClientCertificate, the server must have the same information as the customer. In general, this information is that used to find the encryption key using the “F” function. In the specific embodiment applied to EAP-TLS, the server must have the same arguments for the PRF function as those used by the client: MasterSecret, client certificate, ClientRandom and ServerRandom.

Below is presented a case of a security module implementing the method for protecting the client identity, as well as the integration of such modules in a RADIUS type authentication server. It is clear however that the invention is not restricted to this specific application, and may also be used for other types of authentication servers and more generally in all cases where identity protection mechanisms are sought.

### 2. Description of the Security Module

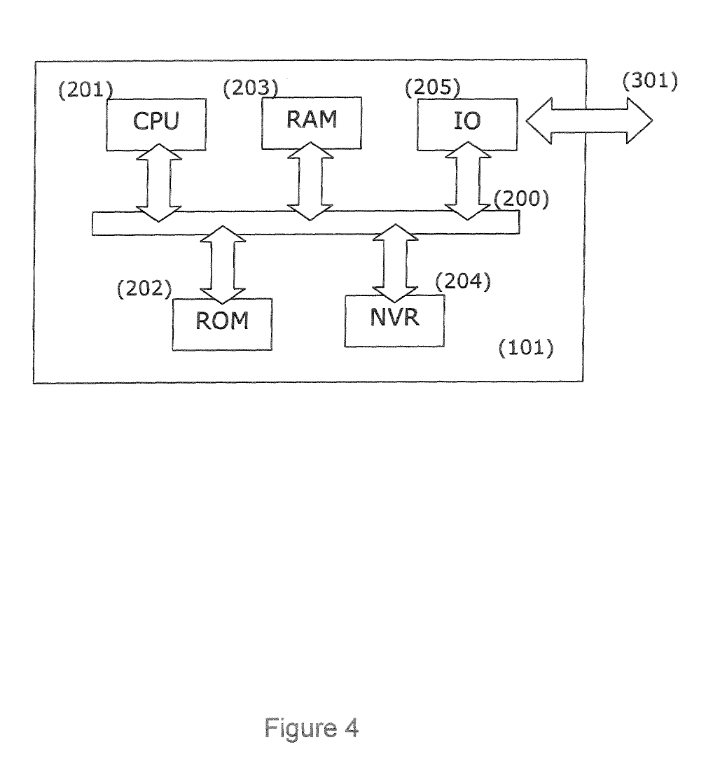

In this embodiment, in relation to FIG. 4, a security module is presented which implements the identity protection method of an embodiment of the invention.

The term security module is used to designate an integrated silicon circuit (101), usually called a Tamper resistant Device, such as for example an ST22 component from ST Microelectronics (registered trademark) and available in different formats such as PVC cards (chip cards, SIM cards, etc.) integrated into USB sticks or in MMC (multi-media card) memories.

Such a security module incorporates all of the secure data storage means and also permits software to be run in a safe and protected environment.

More precisely, such a security module features a CPU (201), a ROM which stores the code of the operating system (202), a RAM (203) and a non-volatile memory (NVR, 204) used as a storage device analogous to a hard disk, and which contains for example integrated TLS or EAP-TLS software. A system bus (200) connects the various parts of the secure module. The interface with the outside world (301) is via an I/O input/output port (205) compliant with standards such as ISO7816, USB, ISO 7816-12, MMC, IEEE 802.3, IEEE 802.11, etc.).

Java cards can form a specific class of security module. In the current state of the art, it is possible to load and run in these components programs that are compliant with the specifications of the TLS protocol, in client and server mode. By way of illustration, such software is known by the name of OpenEapSmartCard. Scientific articles already describe customer creations and EAP-TLS servers in java cards. The identity protection method already described, in view of the description made above, may easily be implemented by a person skilled in the art in client (or server) EAP-TLS software run in a java card.

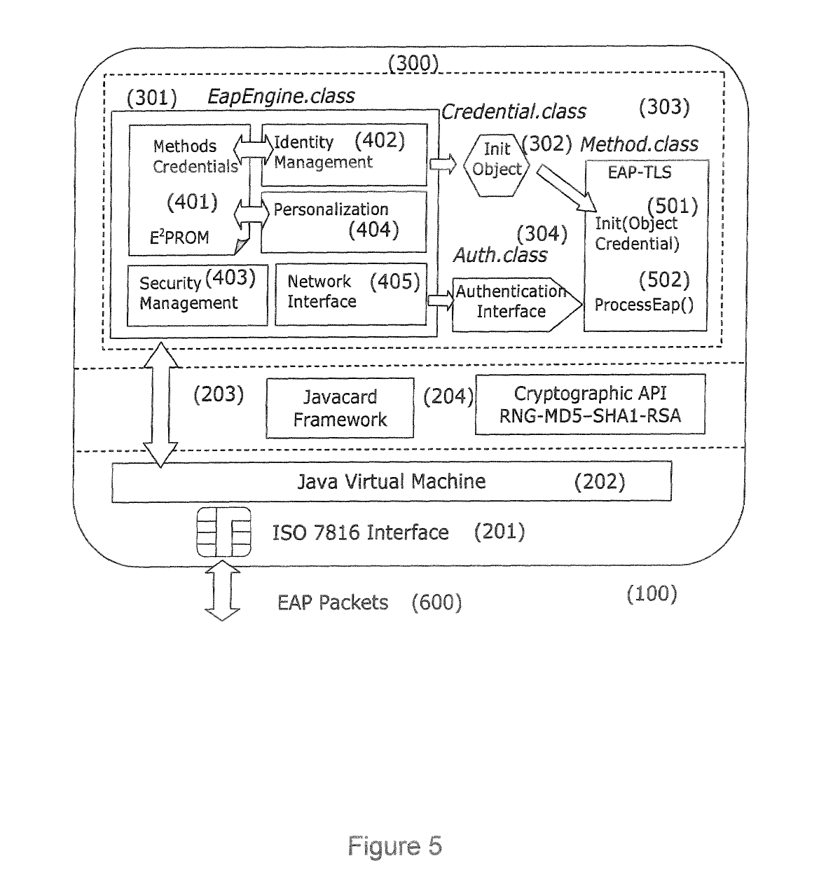

In relation to FIG. 5, a practical embodiment is described of an EAP-TLS application in a java card context.

Such a component (100) commonly has a communication interface compliant with the ISO 7816 standard (201), an integrated java machine (202) and a set of java classes (203) defined by the Java Card Forum which especially permits the use of a library of encryption functions (204). The EAP-TLS application (300) is then defined as a set of java modules.

The EAPEngineClass (301) provides four fundamental services:
the management (402) of the credit letters of the card holder, which is to say sensitive data such as private RSA keys or X509 certificates, stored in a non volatile memory (401);
the personalisation (404) of the security module, which is to say all of the operations required to write the data of the card holder in the memory of the component;
the management of the security (403) of the chip card, the use of which is protected for example by a PIN code associated to a blocking mechanism after three incorrect presentations;
the interface with the network (405) which analyses the EAP packets received and transmits them to the EAP-TLS method.

The EAP-TLS authentication method is carried out by the Method.class module (303). It is initialised with the data associated to a specific context (certification authority certificate, CA, client certificate, private RSA key, etc.) using a, Init procedure (501) of which the argument is a credential.class java object (302).

The EAP messages (600) analysed by the network interface (405) are processed by the ProcessEap procedure (502) of the Method.class module (303). The Auth.class java interface (304) provides the logic link between the EapEngine.class (301) and Method.class (303) modules.

### 3. Client Security Module

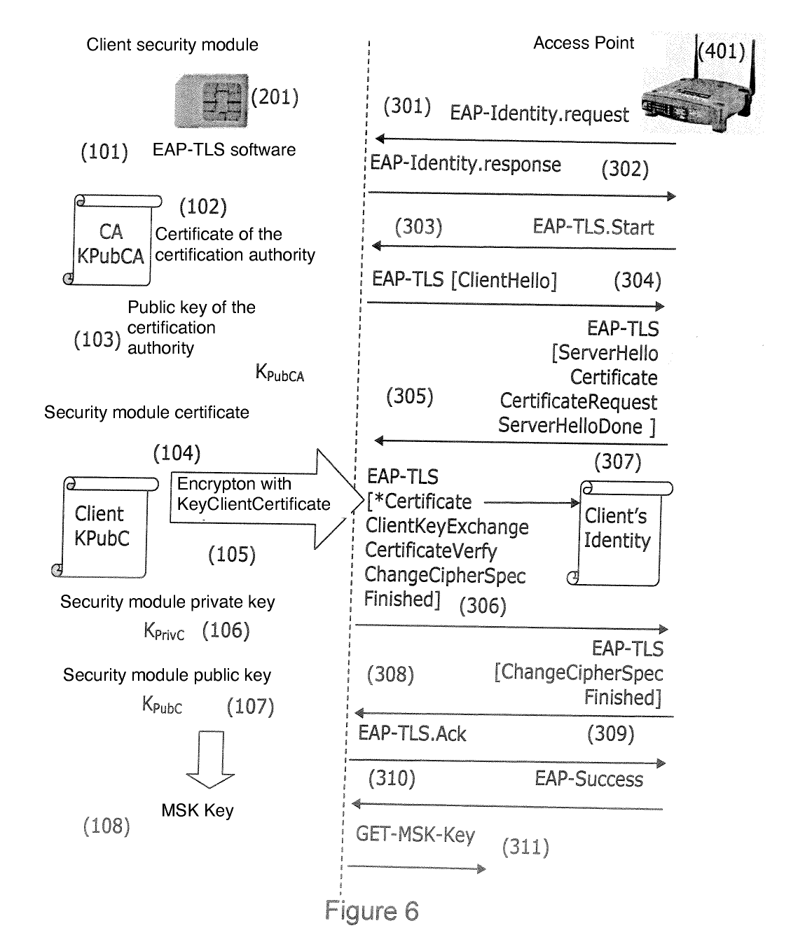

In relation to FIG. 6, a security module (201) is described which contains client EAP-TLS software (101). This program runs the TLS protocol, it receives via an input/output communication port (FIG. 4, 205) EAP-TLS messages and creates the appropriate responses. Furthermore, the module stores the certificate of at least one CA certification authority (102) and its public RSA key (103). The identity of the module, which is to say the client certificate (104) is also stored securely. However this certificate is never provided in decoded form to the outside world. The public (107) and private (106) RSA keys are also managed by the security module. At the end of the EAP-TLS protocol, an MSK key (108) is available for the entity using the module, typically an operating system;

The EAP-TLS authentication dialogue will be described more precisely, from the point of view of the client security module (201) using the identity protection protocol of an embodiment of the invention.

An access point (401) indicates to the client the occurrence of a new authentication session by sending an EAP-Identity.request message (301). The security module inserts its identifier (EAP-ID) in an EAP-Identity.response message (302). It is recommended, without this being considered as restrictive, that this identifier provides information concerning the authentication server and not concerning the client. The authentication server transmits an EAP-TLS.start packet (303) which starts an EAP-TLS session. In response to this event, the client emits an EAP-TLS message carrying the ClientHello type TLS packet (304).

In compliance with the TLS protocol previously described, the server sends a series of messages (ServerHello, Certificate, CertificateRequest, ServerHelloDone) which define in particular the server certificate, its public key, the CA (Certification Authority) certificate and the type(s) of client certificates recognised by the server.

When the EAP-TLS message (305) is received, the client analyses the validity of the server certificate, extracts the associated public key, selects a random PreMasterSecret value and encrypts this value (with the public key of the server) in a ClientKeyExchange message. The client certificate is encrypted with the KeyClientCertificate key previously described, according to the identity protection method. The series of TLS messages (307), Certificate, ClientkeyExchange, CertificateVerify, Finished is inserted in an EAP-TLS packet and sent to the server.

The server verifies this list of messages and notifies the correct completion of this operation by the ChangeCipherSpec and Finished messages (308), encapsulated in an EAP-TLS packet. The client confirms the reception (308) by an EAP-TLS acceptance (309).

The server ends the EAP-TLS session by an EAP.success message (310). After receipt of this indication, the client calculates a master secret key (MSK) (108). The latter is made available to the operating system of the client, by means of the specific security module (311).

Running TLS or EAP-TLS client software (101) with a security module (201) equipped according to an embodiment of the invention with an identity protection mechanism provides the following advantages:
the certificate of the server (305) is verified in a secure computer environment;
the client software (101) only communicates its encrypted (106) identity (104) to a server entity it trusts, and which is the only one able to decode this information;
it carries out the non-repudiation of its decision by means of the signature, based on its private RSA key K_{privc} (106) contained in the CertificateVerify message (307).

Due to their constitution, the TLS messages exchanged between server and client may be read and analysed by any observer of the network. In the case of a dialogue with identity protection, as proposed by an embodiment of the invention, the only information obtained by an observer will be the identity of the server. This is not critical information in the case of an authentication procedure.

### 4. Server Security Module

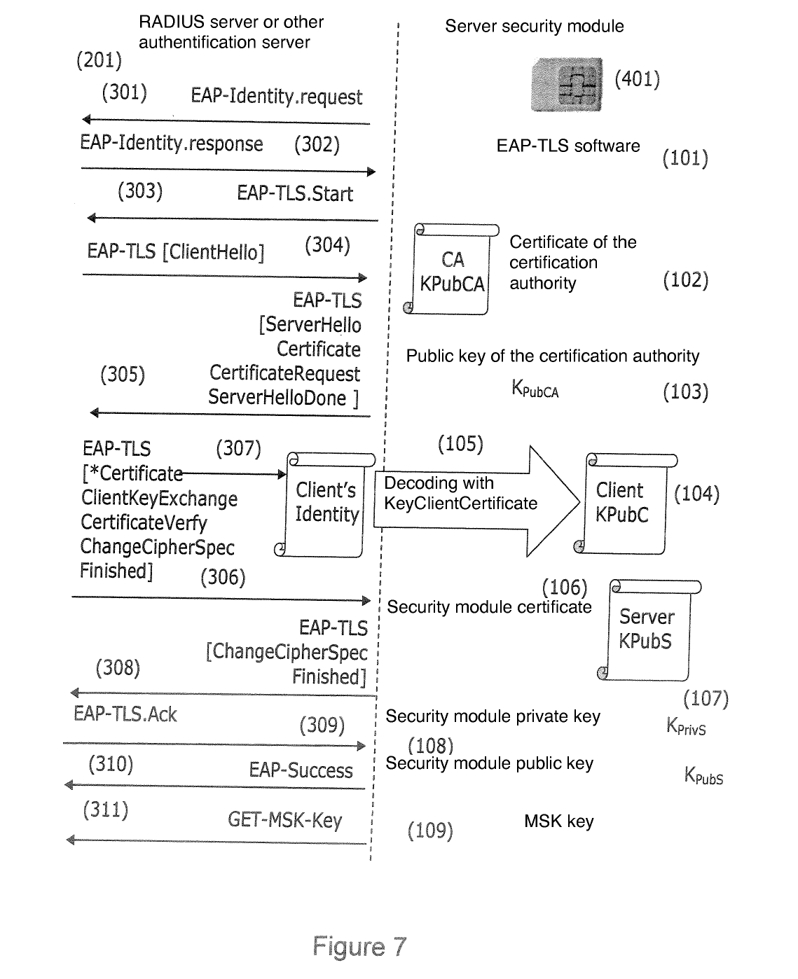

In relation to FIG. 7, a security module (401) is presented which contains server EAP-TLS software (101). This program runs the TLS protocol, it receives via an input/output communication port (FIG. 4, 205) EAP-TLS packets and creates appropriate messages. Furthermore, the module stores the certificate of at least one certification authority (102) and its public RSA key (103). The certificate of the server (107) and its public (109) and private (108) RSA keys are also managed by the security module. At the end of the EAP-TLS protocol, an MSK key (108) is available to the entity using the module, such as for example a RADIUS authentication server.

Below is a description of the EAP-TLS authentication dialogue, from the point of view of the server security module (101). This module is physically or logically connected to an authentication server for example of the RADIUS type (201) or any other device using an EAP server entity. The EAP server receives an EAP-Identity.request message (301) which marks the initialisation of an EAP session. It sends an EAP-TLS.start message (303) which indicates the start of an EAP-TLS session.

The remote client sends an EAP-TLS packet (305) which transports a ClientHello (304) message. The server then sends a series of messages (ServerHello, Certificate, CertificateRequest, ServerHelloDone). When the message (305) is received, the client analyses the validity of the server certificate, extracts the associated public key, selects a random PreMasterSecret value and encrypts this value (with the public key of the server) in a ClientKeyExchange message. The client certificate (307) is encrypted with the KeyClientCertificate key previously described. The series of TLS messages (306), Certificate, ClientkeyExchange, CertificateVerify, Finished is inserted in an EAP-TLS packet and sent to the server.

The server verifies this list of messages, and in particular it finds the PreMasterSecret value using its Kₚᵣᵢᵥₛ key. It then calculates the KeyClientCertificate and obtains the decoded certificate from the client. It notifies the correct completion of this operation by the ChangeCipherSpec and Finished messages (308), encapsulated in an EAP-TLS packet.

The client confirms the reception of the ChangeCipherSpec and Finished messages (308) by an EAP-TLS (309) quit. The security module finishes the EAP-TLS session with an EAP-Success message (310) and calculates a master secret key MSK (108). The latter is made available to the operating system of the server (201) by means of a specific command (311) of the security module.

Running TLS or EAP-TLS client software (101) with a security module (201) equipped according to an embodiment of the invention with an identity protection mechanism provides the following advantages:
the server security module, which is the only one which knows and is able to use the private key kₚᵣᵢᵥₛ (108), is the only entity that knows the identity of the client;
the identity of the client is furthermore certified by the Certificateverify message (306);
the validation of this identity is indicated by an encryption method in the last message Finished (309) emitted by the server.

When an authentication server for example of the RADIUS type, uses a server security module, the latter makes available an MSK key (109), used for example, to ensure the security of the communications between an access point and wireless network client pair.

An embodiment of the invention thus provides a technically innovative solution by allowing the connection of a client to be managed and then making available to the security infrastructure the MSK key of this client, without rendering its identity public.

### 5. Implementation of Security Modules in an Authentication Infrastructure

An embodiment of the invention is presented in a RADIUS type authentication infrastructure. A network infrastructure is therefore considered which supports a large number of clients, equipped with EAP-TLS security modules according to an embodiment of the invention. These clients are administered by one or several RADIUS servers in functions of the network constraints.

An embodiment of the invention permits an optimum level of confidence to be attained when the authentication sessions are run by client and server EAP security module pairs. In this infrastructure, each server is capable of managing multiple EAP-TLS sessions simultaneously.

In this infrastructure, the operating systems of the security modules usually supervise counter-measures, designed to protect against attacks by physical and logical intrusion. These counter-measures significantly reduce the calculation performances of these components.

We will now describe a method of implementing multiple security modules by a RADIUS authentication server. This method authorises the management of several simultaneous sessions and makes possible the use of server security modules in networks which support a large population of users without a drop in performances.

### 6. Description of the Infrastructure

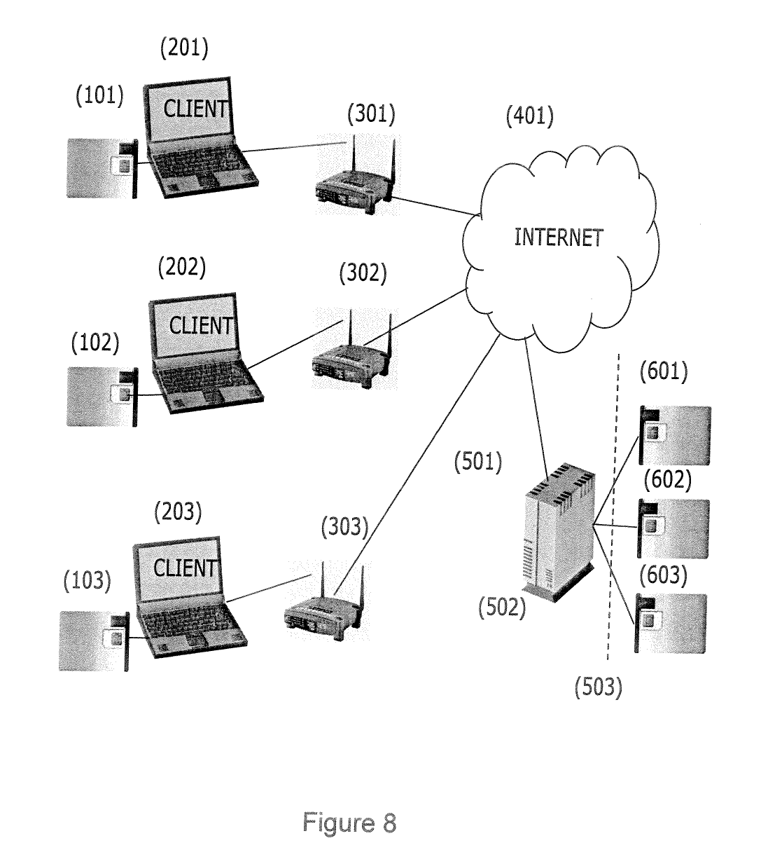

In relation to FIG. 8, a RADIUS infrastructure is presented used to take advantage of the identity protection method according to an embodiment of the invention. A set of clients (201, 202, 203) optionally equipped with security modules (101, 102, 103) are controlled by network administration servers (NAS) (301, 302, 303) located for example in access points of this network. Each one is associated, by means of the Internet network 401, to a single RADIUS authentication server (501), by software (502) run by a computer system equipped with an operating system. This RADIUS server is further capable of exchanging, by means of physical and/or logical interfaces 503, information with a plurality of server security modules (601, 602, 603).

At present, many free software programs such as OPENRADIUS or FREERADIUS offer RADIUS authentication services. Security modules can be integrated into these software programs by physical (503) and/or software interfaces supported by many operating systems, such as USB or PC/SC (personal computer smart card).

### 7. Messages Exchanged

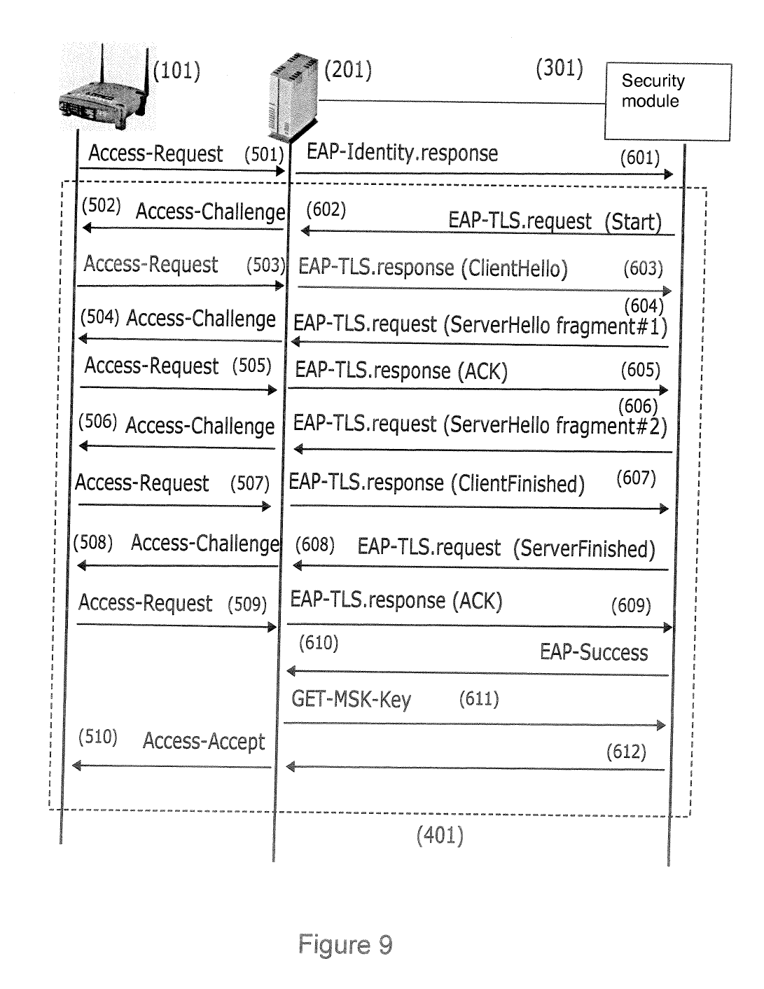

In relation to FIG. 9, the detail of the information exchanged is presented, in the form of messages between a NAS, presented in the form of an access point (101), a RADIUS authentication server (201) and an EAP-TLS security module (301). The latter comprises, in compliance with the previous descriptions, a private RSA key and X509 certificate from a certification authority.

The term RADIUS session (401) is used to designate a series of packets exchanged between the NAS and the RADIUS authentication server. These packets carry the information exchanged between an EAP client and an EAP server.

As concerns the RADIUS server, a session starts with the reception of an EAP-Identity.response message (601), includes an access-request packet (501) and ends by the generation of a notification, typically an EAP-success (610) in an access-accept packet (510).

An EAP-Identity.response message is transported by a RADIUS access request packet (501). An EAP-TLS request message called EAP-TLS.start (602) is transmitted to the access point in a RADIUS access-challenge packet (502). The EAP-TLS message encapsulating the TLS ClientHello protocol element (603) is transported by the RADIUS access-request packet (503).

The TLS packet containing the series of ServerHello, Certificate, CertificateRequest and ServerHelloDone messages is typically broken down according to the rules of the EAP-TLS protocol, into two fragments (604) (606). Each one is transported in a RADIUS access challenge packet (504) (506). The first fragment is acquitted by an EAP-TLS message (605) transported by a RADIUS packet (505). After the reception of the second and last fragment, (606), the client (who wishes to be identified and authenticated) analyses the re-assembled message.

During the reception of the second fragment (606), the client analyses the validity of the server certificate, extracts the associated public key, selects a random PreMasterSecret value and encrypts this value (with the public key of the server) in a ClientKeyExchange message. The client certificate is encrypted with the KeyClientCertificate key previously described. The series of TLS messages Certificate, ClientKeyExchange, CertificateVerify and Finished is inserted in an EAP-TLS Packet (607) then in a RADIUS access-request packet (507) and sent to the server.

The server verifies this list of messages, and in particular finds the PreMasterSecret value, calculates the KeyClientCertificate and obtains the decoded client certificate. If this operation is successful, the ChangeCipherSpec and Finished messages are encapsulated in an EAP-TLS packet then in a RADIUS access-challenge message (508).

An EAP-TLS acquittal message (609) is transported in a RADIUS access-request message (509).

The security module then indicates the success of the authentication by means of the EAP-success message. The RADIUS server reads the MSK key by means of a specific command (611) and creates the last RADIUS access-accept message (510) which especially comprises the two halves MS-MPPE-sendkey and MS-MPPE-recvkey from the MSK key.

In view of the above description, it may be observed that the server security module notifies the success of an authentication and provides an MSK key to the RADIUS server without revealing the identity (the certificate without encryption) of the client.

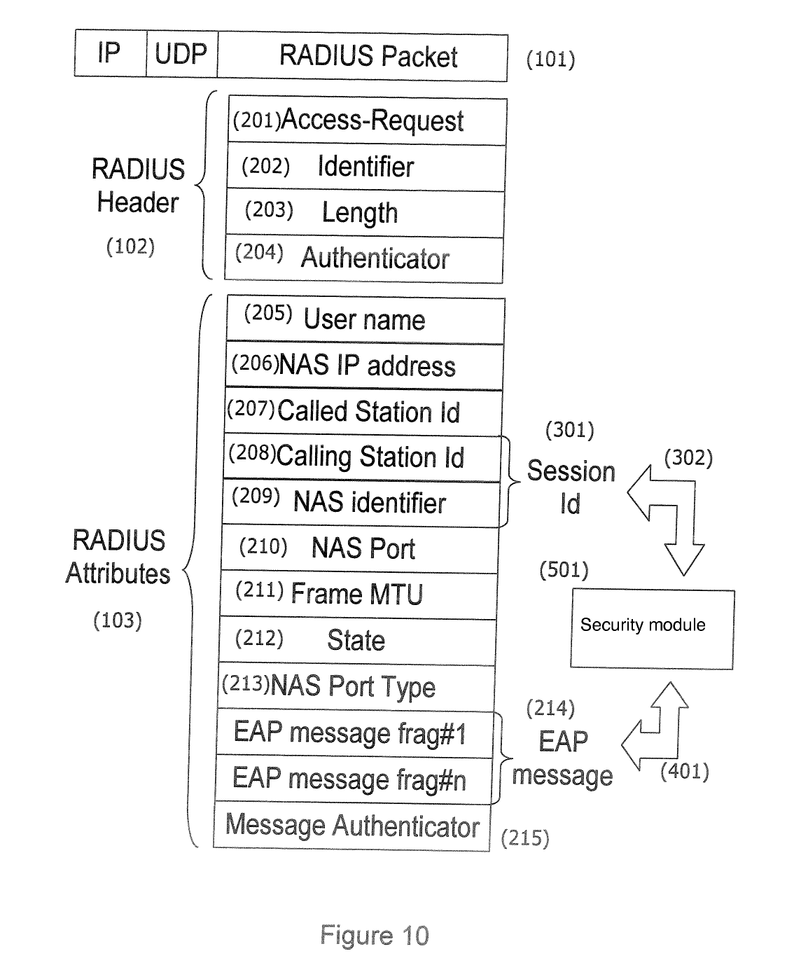

In relation to FIG. 10, the content of a RADIUS packet is presented, of the access-request type. Such messages are transmitted by multiple NAS (Network Access Server) to a RADIUS authentication server (FIG. 8, 501). An access-request packet transports, among other information, an EAP response. A RADIUS server which receives this packet creates in return an Access-Challenge, Access-Accept or Access-Reject type message, encapsulating in general an EAP request or notification.

The content of an access-request packet (101) will now be presented in detail, transported by the IP and UDP (user datagram protocol) communication piles which has two parts, a header (102) and a list of attributes 103).

The header features the message code (201) or access-request in our example, a label (202) such that the value of a response is equal to the value of a request, the length of the packet (203) and a random 16 octet number (204).

A RADIUS message transports a variable number of attributes (205, 206, 207, 208, 209, 210, 211, 212, 213, 214, 215) that are identified in FIG. 10 by a name allocated by the RFC 2865 and RFC 3559 standards.

From the point of view of the RADIUS server, a session is identified by a list of information related to the distant client (205, 208) and a list of information related to the NAS used by the client (206, 207, 209, 210, 213). Each session is associated to a unique identifier (session-ID) obtained by the concatenation of attributes included in an access-request message. By way of example, we can construct the session-ID value (301) by concatenation of the two following attributes:

Session-ID=NAS-Identifier|calling station-ID

NAS identifier (209) (RADIUS attribute number 32) is a unique identifier of the NAS delivered by the network administrator or equipment manufacturer.

Calling-Station-Id” (208) (RADIUS attribute number 31) is a unique identifier of the client, for example the unique MAC address of the network board used).

In relation with the identity protection protocol according to an embodiment of the invention, the authentication server attributes to each session, uniquely identified by the session-ID value, a security module. When there are no security modules available, the access-request packet is ignored by the RADIUS software, and consequently the distant NAS does not receive any notification of this event.

An EAP message is encapsulated, in function of its size, by one or several attributes (214) whose useful length is 254 octets.

The software of the RADIUS server verifies the correct value of the attribute (215), a HMAC-MD5 protected by a secret key (called the RADIUS secret). If this is successful, the EAP message is re-assembled and then sent to the security module (501) associated to the RADIUS session identified by (301). Consequently, the server security module, using the identity protection method according to an embodiment of the invention, is able to provide the identity of the client terminal to the RADIUS server so as to obtain the assertion of the authentication from the latter. Subsequently, when each authentication module manages at most one session, the maximum number of authentication sessions managed simultaneously by a RADIUS server software program is equal to the number of security modules.

However, technological progress, especially in terms of performance, permits the simultaneous management of several authentication sessions to be envisaged by a same security module. In this case, the RADIUS software may attribute several sessions to each security module.

Although the present disclosure has been described with reference to one or more examples, workers skilled in the art will recognize that changes may be made in form and detail without departing from the scope of the disclosure and/or the appended claims.

1. A method for authenticating a client terminal by an authentication server, wherein said client terminal has an authentication certificate, wherein the method comprises the following phases:
retrieving at least one encrypting parameter by said client terminal;
encrypting said encrypted authentication certificate by said client terminal from said at least one encrypting parameter, providing an encrypted authentication certificate;
transmitting said encrypted authentication certificate to said server;
obtaining said at least one encrypting parameter by said server;
decoding said encrypted authentication certificate from said at least one encrypting parameter;
authenticating and supplying an assertion of the authentication if the authentication is positive.

2. The method set forth in claim 1, wherein said encrypting phase of said authentication certificate by said client terminal comprises the steps of:
calculating, by said client terminal, a certificate encryption key as a function of at least one encrypting parameter;
encrypting said authentication certificate, using said certificate encryption key.

3. The method set forth in claim 1, wherein said retrieving phase of said at least one encryption parameter by said server comprises the steps of:
encrypting said at least one encrypting parameter by said client terminal as a function of at least one public key transmitted by said server to said terminal;
transmitting at least one encrypted encrypting parameter by said client terminal to said server;
decoding said at least one encrypted encrypting parameter by said server as a function of at least one private encryption key asymmetric to said at least one public encryption key.

4. The method set forth in claim 1, wherein said at least one encryption parameter belongs to the group comprising at least:
an item of information that is representative of a random number obtained by said authentication server;
an item of information that is representative of a random number obtained by said client terminal;
an item of information that is representative of a number encrypted with said public key of said authentication server.

5. The method set forth in claim 1, wherein the method is used in an SSL and/or TLS protocol.

6. The method set forth in claim 5, wherein the method is used in the EAP protocol.

7. An identify encryption method of a client terminal, which has an authentication certificate, during an authentication of said terminal by an authentication server, wherein the method comprises the steps of:
retrieving at least one encrypting parameter by said client terminal;
encrypting said encrypted authentication certificate by said client terminal from said at least one encrypting parameter;
transmitting said encrypted authentication certificate to said server.

8. An identity encryption device for a client terminal, which has an authentication certificate, during an authentication of said terminal by an authentication server, wherein the device comprises:
means for retrieving at least one encrypting parameter;
means for encrypting said authentication certificate from said at least one encrypting parameter;
means for transmitting said encrypted authentication certificate to said server.

9. The identity encryption device set forth in claim 8, wherein the device is used in a chip card using a virtual machine.

10. A method for decoding an identity of a client terminal, which has an authentication certificate, by an authentication server in an authentication of said terminal by said authentication server, wherein the method comprises the steps of:
receiving an encrypted authentication certificate from said client terminal;
retrieving at least one encrypting parameter by said server;
decoding said encrypted authentication certificate from said at least one encrypting parameter;
authenticating and supplying an assertion of the authentication if the authentication is positive.

11. A device for decoding an identity of a client terminal, which has an authentication certificate, by an authentication server in an authentication of said terminal by said authentication server, wherein the device comprises means of:
receiving an encrypted authentication certificate from said client terminal;
retrieving at least one encrypting parameter by said server;
decoding said encrypted authentication certificate from said at least one encrypting parameter;
authenticating and supplying an assertion of the authentication if the authentication is positive.

12. The device for decoding the identity of a client terminal set forth in claim 11, wherein the device is used in a chip card using a virtual machine.

13. A computer software program stored on a computer readable support and comprising program code instructions to execute a method for authenticating a client terminal by an authentication server, when the program is run on a computer, wherein said client terminal has an authentication certificate and wherein the method comprises:
retrieving at least one encrypting parameter by said client terminal;
encrypting said encrypted authentication certificate by said client terminal from said at least one encrypting parameter, providing an encrypted authentication certificate;
transmitting said encrypted authentication certificate to said server;
obtaining said at least one encrypting parameter by said server;
decoding said encrypted authentication certificate from said at least one encrypting parameter;
authenticating and supplying an assertion of the authentication if the authentication is positive.

14. A computer software program stored on a computer readable support and comprising program code instructions to execute an identify encryption method of a client terminal during an authentication of said terminal by an authentication server when the program is run on a computer, wherein the client terminal has an authentication certificate and wherein the method comprises:
retrieving at least one encrypting parameter by said client terminal;
encrypting said encrypted authentication certificate by said client terminal from said at least one encrypting parameter;
transmitting said encrypted authentication certificate to said server.

15. A computer software program stored on a computer readable support and comprising program code instructions to execute a method for decoding an identity of a client terminal by an authentication server in an authentication of said terminal by said authentication server when the program is run on a computer, wherein the client terminal has an authentication certificate and wherein the method comprises:
receiving an encrypted authentication certificate from said client terminal;
retrieving at least one encrypting parameter by said server;
decoding said encrypted authentication certificate from said at least one encrypting parameter;
authenticating and supplying an assertion of the authentication if the authentication is positive.
